(19) United States
(12) Patent Application Publication
(10) Pub. No.: US 2008/0109509 A1
(43) Pub. Date: May 8, 2008

(54) Computer architecture for communicating between objects

(75) Inventors: Joel Lee Dickerson, Mesa, AZ (US); David Murray Jacques, Gilbert, AZ (US); Lisa South Begin, Phoenix, AZ (US); Jeffrey Todd Hallock, Tempe, AZ (US); Jeremy Vincent Davis, Phoenix, AZ (US)

Correspondence Address: HAVERSTOCK & OWENS LLP, 162 N WOLFE ROAD, SUNNYVALE, CA, 94086, US

(73) Assignee: Supercritical Systems, Inc.

(21) Appl. No.: 10/600,154

(22) Filed: Jun. 20, 2003

(51) Int. Cl. G06F 15/16

(52) U.S. Cl. 709/201; 709/207

(57) ABSTRACT

An apparatus and method of passing messages between client systems is disclosed. The apparatus comprises a first client system and a second client system. The first client system assigns a priority to a message and transmits the message to the second client system. The second client system processes the message based on the priority. The apparatus can also include a message server coupled to both the first client system and the second client system and used to transmit the message from the first client system to the second client system. The apparatus can also include a log server, a diagnostics server, or both, which are both coupled to the message server and used to store log data used for archiving and diagnosis.

### FIELD OF THE INVENTION

This invention relates to the field of electronic data transmission. More specifically, this invention relates to message passing between computer systems.

### BACKGROUND OF THE INVENTION

Electronic messages are exchanged in a number of environments. Messages can be exchanged between employees in geographically-dispersed corporate offices, between programs that monitor inventories and programs used to order supplies, or between systems that monitor manufacturing equipment and systems that control operating conditions or alert service personnel when problems arise. Indeed, with the rise of the Internet and the reliance on communications over networks, electronic messages are used in a variety and increasing number of ways.

It is difficult to monitor and process a large number of messages. For example, when messages relating to operating conditions in a manufacturing plant are monitored by a human operator, it is difficult for the operator to determine which of the messages should be processed quickly. The number of messages exchanged in a manufacturing or other environment also makes it difficult to retrieve and process the messages. Accordingly, there is a continued need for new methods and systems for transmitting and processing electronic messages exchanged between systems.

### BRIEF SUMMARY OF THE INVENTION

A message-passing system allows a message to be passed between client systems and processed on a client system based on a priority assigned to the message. A message with a high priority can thus be processed before messages with lower priorities. Messages can also be logged so that they can be archived and possibly analyzed.

In a first aspect of the present invention, a message-passing system comprises a first client system configured to transmit a message packet containing a priority to a second client system, and a second client system configured to receive the message packet from the first client system and process the message packet based on the priority. The message packet can be transmitted from the first client system to the second client system according to a transport protocol. Preferably, the transport protocol is TCP/IP, but it can be NetBUI or any other transport protocol. The message packet can be formatted according to an SGML standard, such as XML. The message packet can comprise text data, a virtual object, or any other type of data.

In accordance with one embodiment of the present invention, the message-passing system further comprises a first message server coupling the first client system to the second client system. The first message server provides a communication path between the first client system and the second client system. The message-passing system can further comprise a log server coupled to the first message server. The log server is configured to store log data for the message packet. The message-passing system can further comprise a diagnostics server coupled to the first message server. The diagnostics server is configured to store log data for the message packet.

In accordance with another embodiment of the present invention, the message-passing system further comprises a second message server and a load balancer. The second message server couples the first client system to the second client system and provides a communication path between the first client system and the second client system. The load balancer couples the first client system to both the first message server and the second message server. The load balancer further couples the second client system to both the first message server and the second message server.

In accordance with yet another embodiment of the present invention, the message-passing system further comprises a manufacturing equipment having an associated parameter. The manufacturing system is coupled to the first client system. The first client system is configured to monitor the associated parameter, generate the priority based on the parameter, generate the message packet containing the priority, and transmit the message packet to the second client system. Preferably, the manufacturing equipment comprises a semiconductor processing system.

In a second aspect of the present invention, a method of passing a message packet between a first client system and a second client system comprises generating a message packet containing a priority-on the first client system, transmitting the message packet from the first client system to the second client system, receiving the message packet on the second client system, and processing the message packet on the second client system according to the priority. The message packet can be transmitted from the first client system to the second client system according to a transport protocol. The transport protocol can be TCP/IP, NetBUI, or any other transport protocol.

In accordance with one embodiment of the present invention, generating a message packet comprises formatting a message according to an SGML standard. Preferably, the SGML standard is XML. The message packet can comprise text data, a virtual object, or any other type of data.

In accordance with another embodiment of the present invention, the method further comprises storing log data for the message packet.

In accordance with another embodiment of the present invention, transmitting the message packet comprises transmitting the message packet to a message server based on a load of the message server and transmitting the message packet from the message server to the second client system. Generating a message packet can comprise encrypting a message and including the encrypted message in the message packet. Processing the message packet can comprise decrypting the encrypted message in the message packet.

In accordance with yet another embodiment of the present invention, the method further comprises reading a parameter associated with a manufacturing equipment, and generating the priority based on the parameter.

In a third aspect of the present invention, a sending client system is configured to transmit a message packet containing a priority to a receiving client system, which is configured to process the message packet based on the priority. In accordance with one embodiment, the sending client system comprises a messaging module. The messaging module is configured to assign a priority to a message to form the message packet. The messaging module is further configured to transmit the message packet to the receiving client system according to a transport protocol. Preferably, the transport protocol is TCP/IP, but it can be NetBUI or any other transport protocol.

In a fourth aspect of the present invention, a receiving client system is configured to receive a message packet containing a priority from a sending client system. The receiving client system is configured to process the message packet based on the priority. In one embodiment, the receiving client system comprises a messaging module. The messaging module is configured to receive the message packet from a sending client system according to a transport protocol. The messaging module is further configured to process the message packet based on the priority. Preferably, the transport protocol is TCP/IP, but it can be NetBUI or any other transport protocol.

### BRIEF DESCRIPTION OF THE SEVERAL VIEWS OF THE DRAWINGS

FIG. 1 illustrates a message-passing system, in accordance with one embodiment of the present invention, having client systems, a message server, a log server, and a diagnostics server.

FIG. 2 is a flow chart for steps performed on a client system, in accordance with one embodiment of the present invention.

FIG. 3 is a flow chart for steps performed by a process executing on a message server, in accordance with one embodiment of the present invention.

FIG. 4 is a flow chart for steps performed by a thread dispatched by the process illustrated in FIG. 3.

FIG. 5 is a flow chart for steps performed by a process executing on a client system, in accordance with one embodiment of the present invention.

FIG. 6 shows an XML document containing a message generated by a client system, in accordance with one embodiment of the present invention.

FIG. 7 schematically shows a memory for a client system, storing message packets and an array used to process the message packets, in accordance with one embodiment of the present invention.

FIG. 8 shows an XML document containing an object generated by a client system, in accordance with one embodiment of the present invention.

FIG. 9 shows a load-balanced message-passing system, in accordance with one embodiment of the present invention.

FIG. 10 is a message-passing system having workstations for transmitting messages, in accordance with one embodiment of the present invention.

FIG. 11 is a message-passing system for transmitting messages in a manufacturing environment, in accordance with one embodiment of the present invention.

### DETAILED DESCRIPTION OF THE INVENTION

Message-passing systems in accordance with the present invention are particularly useful in manufacturing and other environments. For example, a message-passing system having one or more pieces of manufacturing equipment can be used to monitor the manufacturing equipment and send error, diagnostics, and other messages to a central controller or to a machine monitored by a human operator. Each piece of manufacturing equipment can be coupled to its own sending client system, which monitors a parameter associated with a manufacturing equipment, such as a temperature or pressure. A sending client system can then format a message relating to the temperature or pressure, assign the message a priority, format the message, the priority, and other information into a message packet, and transfer the message packet to a receiving client system, such as a control system. The control system uses the priority to process message packets from the sending client system and other sending client systems, generally processing message packets with higher priorities before message packets with lower priorities. The message-passing system can also store log data relating to message packets for archiving and later diagnosis of the functioning of manufacturing equipment.

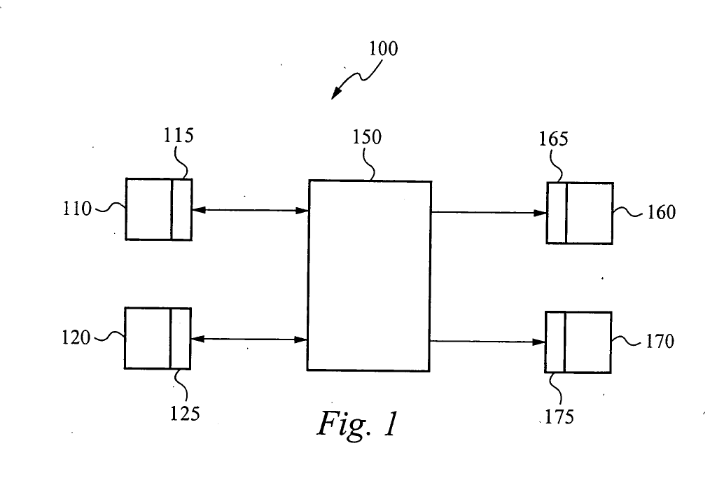

FIG. 1 shows a message-passing system 100 in accordance with one embodiment of the present invention. The message-passing system 100 comprises a first client system 110 and a second client system 120 coupled to a message server 150. The message server 150 is coupled to a log server 160 and a diagnostics server 170. The first client system 110 comprises a messaging module 115 and the second client system 120 comprises a messaging module 125. The log server 160 comprises a messaging module 165, and the diagnostics server 170 comprises a messaging module 175. As described in more detail below, the messaging modules 115 and 125 store, send, and retrieve messages exchanged between client systems. The messaging modules 165 and 175 store and retrieve messages received from client systems and stored on the log server 160 and the diagnostics server 170, respectively. It will be appreciated that the dedicated message server 150, the log server 160, and the diagnostics server 170 are not required to practice the present invention but are shown merely to illustrate one embodiment of the present invention. For example, the message server 150 is not needed when client systems communicate across a LAN or across a dedicated telephone line. The message server 150 can also be part of a public packet-forwarding device such as a router that forms part of the Internet.

In operation, the first client system 110 transmits a message to the second client system 120 as follows. First, a process running on the first client system 110 generates the message. The process can be a program that reads values on a port and sends a message containing the value from the first client system 110 to the second client system 120, as described in more detail below. Alternatively, the process can be another executing program performing other tasks. The process then passes to the first messaging module 115 either the message, a reference to where the message is stored in memory, or a virtual object related to the message. The first messaging module 115 stores the message, the reference, or the virtual object in an outgoing message queue. Preferably, the first messaging module 115 then formats the message to generate a message packet and transmits the message packet to the message server 150. Alternatively, the message is formatted by the process generating the message or by other processes running on the first client system 110 to create a message packet. The message packet contains the message and other information that can be used to transmit the message packet containing the message to the second client system 120. As described in more detail below, the message packet contains a value indicating a priority of the message. The message packet can ‘also contain a header that’ in turn contains an identifier (such as a hostname) of the first client system 110 and an identifier (such as a hostname) of the second client system 120. Furthermore, the header generally contains other information used to transmit the message between one or more client systems.

Hereinafter, a client system generating and transmitting a message packet is referred to as a sending client system. A client system receiving a message packet is referred to as a receiving client system. A message packet generated on a sending client system is referred to as an outgoing message packet. A message packet received on a receiving client system is referred to as an incoming message packet. It will be appreciated that a client system can be configured to both send and receive message packets and thus can be both a sending client and a receiving client.

Preferably, a message packet is transmitted from the messaging module 115 to the message server 150 using TCP/IP. It will be appreciated, however, that a message packet can be transmitted from the messaging module 115 to the message server 150 using other transport protocols, including, but not limited to, NetBUI.

Once the message server 150 receives the message packet, the message server 150 parses the message packet's header to determine the address of the receiving client system and transmits the message packet to the receiving client system 120. On the receiving client system 120, the incoming message packet is stored in memory (not shown) in the messaging module 125, such as a mailbox. The messaging module 125 reads the priority of the incoming message packet and, based on the priority, processes the incoming message packet. In one embodiment of the present invention, for example, if the memory of the messaging module 125 contains two message packets (waiting message packets) that have not yet been processed, each having a lower priority that the incoming message packet, the messaging module 125 will process the incoming message packet before it processes the waiting messages packets. Processing a message packet can comprise sending the message within the message packet to a waiting process executing on the receiving client system 120, printing the message to a monitor (not shown) forming part of the receiving client system 120, or performing other tasks.

While the above discussion has described sending a message packet from the client system 110 to the client system 120, it will be appreciated that a message packet can also be sent from the client system 120 to the client system 110. Thus, as discussed above, a client system can function as both a sending client system and a receiving client system.

When the message server 150 receives the message packet, it can additionally perform several tasks. For example, the message server 150 can transmit the message packet, the message contained within the message packet, other information related to the message, or a combination of the above to the log server 160. The log server 160 receives the message packet on the messaging module 165, which stores the message packet and can process it for later viewing, retrieval, archiving, or further processing. Hereinafter, the message packet, the message contained within the message packet, other information related to the message, or a combination of the above, transmitted to the log server 160, to the diagnostics server 170, or both is referred to as log data. The log server 160 thus contains log data for each message transmitted along the message-passing system 100. Log data can include, but is not limited to, (1) the hostname of the sending client system 110 and the hostname of the receiving client system 120, (2) the day, time of day, year and month that the message was sent from the sending client system 110 to the receiving client system 120, (3) the priority of the message, or (4) or any other information.

In addition to sending the log data to the log server 160, the message server 150 can also send log data to the diagnostics server 170. The diagnostics server 170 receives the log data on its messaging module 175, which stores the log data and can process it for later viewing, retrieval, or further processing. If, for example, the message is an error message indicating that an error has occurred on the sending client system 110 or on a system monitored by the sending client system 110, the diagnostics server 170 can be used to diagnose the error. For example, the message can contain a data field containing an error code indicating a specific error. The diagnostics server 170 can contain a data store having records with one field containing error codes and a corresponding field containing possible errors and fixes. The data store can be queried to generate reports listing errors found on client systems. The data store can also be queried to determine how a sending client system can be fixed.

While FIG. 1 shows only two client systems 110 and 120, it will be appreciated that the message-passing system 100 can and generally does contain more than two client systems. For example, a message-passing system can comprise first, second, and third client systems coupled to a fourth client system. The first, second and third client systems can each transmit messages to the fourth client system, which can process the messages as described below.

As described above, it will also be appreciated that the message server 150 is not necessary for practicing the present invention. For example, a message packet could be transmitted from a sending client system to a receiving client system over LAN, a dedicated telephone line, and using other methods and systems.

The message-passing system 100 can be used in a variety of environments. For example, the first (sending) client system 110 can monitor manufacturing equipment (not shown), such as a semiconductor processing system, housed in a clean room. The second (receiving) client system 120 can be a control system for controlling the temperature in the clean room. The client system 110 can monitor, for example, the temperature of the manufacturing equipment. When the temperature exceeds a predetermined level, the sending client system 110 generates a message relating to the temperature, assigns a priority to the message based on the temperature, and transmits the message to the receiving client system 120. When the receiving client system 120 receives the message, it can read the priority and then generate a corresponding signal to direct a process control system to cool the clean room and thus the manufacturing equipment. Generally, the higher the temperature, the higher will be the priority assigned to the message, and the quicker the message will be processed.

It will be appreciated that the client systems 110 and 120, the message server 150, the log server 160, and the optional diagnostics server 170 can be connected over one or more networks, such as a local area network (LAN), a virtual private network (VPN), or the Internet. The client systems 110 and 120, the message server 150, the log server 160, and the diagnostics server 170 can also be directly connected or coupled in any combination of ways. For example, the first client system 110 can be coupled to the message server 150 by a network such as the Internet. The message server 150, the log server 160, and the diagnostics server 170 can be the same machine; thus processes controlling the message server 150, the log server 160, and the diagnostics server 170 can communicate using sockets, shared memory, pipes, or other means for exchanging data. The message server 150 and the second client system 120 can be coupled over a LAN. It will also be appreciated that messages exchanged over the message-passing system 100 can be encrypted using shared keys, using public keys, or using other methods including, but not limited to, the use of passwords.

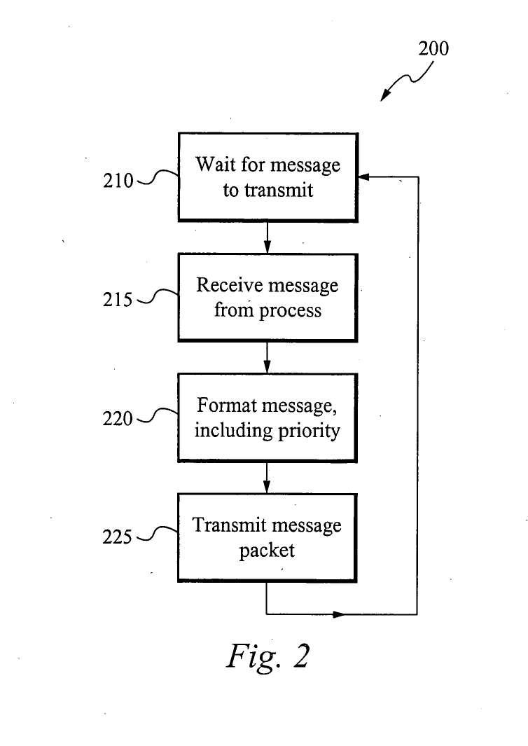

FIG. 2 is a flow chart 200 for the steps performed by the messaging module 115 of the sending client system 110. First, in the step 210, the messaging module 115 waits for an outgoing message packet that is to be transmitted to the receiving client system 120. As described above, the message packet contains a message that is to be transmitted to the receiving client system 120. The message packet also contains a priority value assigned to the message. The outgoing message packet can be sent from a process running on the sending client system 110, such as a program that reads the temperature on manufacturing equipment coupled to the sending client system 110. The process can be configured to transmit a message packet to the messaging module 115 for transmission to the receiving client system 120 when the temperature exceeds a predetermined level. High priorities can correspond to higher temperatures and thus determine the order in which the message is processed on the receiving client system.

Next, in the step 215, the messaging module 115 receives the message and stores the message in its memory. Alternatively, the messaging module 115 receives a reference to the memory shared between a process generating the message and the messaging module 115, where the message is stored. Preferably, the messaging module 115 stores the reference in an outgoing message queue. Next, in the step 220, the messaging module formats the message to generate a message packet containing the message. Preferably, the message packet contains a header and a body containing the message. The header can contain, for example, (1) a priority for the message, (2) a FROM field containing a hostname of the sending client system 110, and (3) a TO field containing a hostname of the receiving client system 120. The sending client system 110 can set the priority to indicate the urgency of the message. For example, a message that manufacturing equipment coupled to the sending client system 110 has an reached an unacceptable temperature will have a higher priority than a message that the manufacturing equipment has not been serviced in one month.

As described in more detail below, preferably the message packet is an XML document. As is known to those skilled in the art, XML documents contain tags useful in retrieving data stored in XML elements, sorting by these data, and otherwise manipulating these data.

Next, in the step 225, the message packet is transmitted to the message server 150. In a preferred embodiment, the message packet is transmitted from the sending client system 110 to the message server 150 using TCP/IP. Thus, for example, transmitting the message packet from the sending client system 110 to the message server 120 preferably comprises creating a socket between the sending client system 110 and the message server 150 or using an already existing socket. Thus, before transmitting the message packet from the sending client system 110 to the message server 150, the sending client system 110 must know the hostname of the message server 150 and the port the message server 150 is configured to receive message packets on.

It will be appreciated that the messaging module 115 can perform tasks in other ways in accordance with the present invention. For example, rather than wait in the step 210, the messaging module 115 can sleep until a message packet is ready to be transmitted from the sending client system 110 to the receiving client system 120 and then awoken when a message packet is ready to be transmitted.

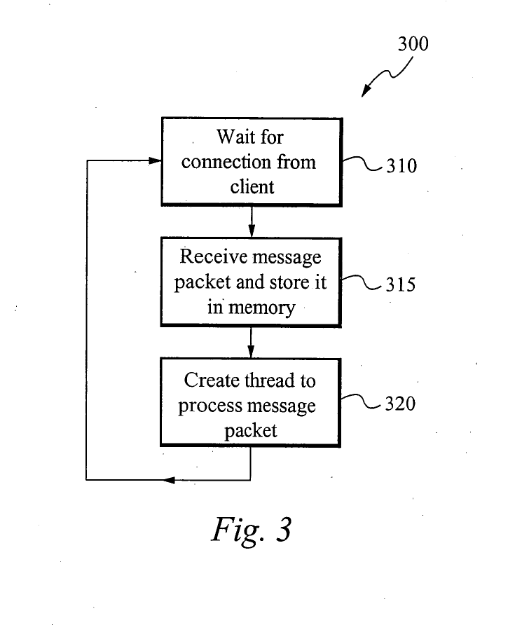

FIG. 3 is a flow chart 300 illustrating the steps performed by the message server 150 in accordance with one embodiment of the present invention. First, in the step 310, the message server 150 waits for a connection from the sending client system 110. That is, the message server 150 waits until the sending client system 110 has created a socket connecting the sending client system 110 to the message server 150. Next, in the step 315, the message server 150 receives a message packet and stores it in the memory of the message server 150. Next, as described in more detail below, in the step 320 the message server 150 creates a thread to process the message packet. The message server 150 then loops back to the step 310 to process other connections from other sending client systems. It will be appreciated that the message server 150 thus contains a parent process that handles connections from sending client systems and also contains thread processes that process messages transmitted over those connections. The client system 110 and the message server 150 thus function as a client-server pair. As will be described in more detail below, in one embodiment of the present invention, the thread processes also transmit the messages to the log server 160 for logging messages, to the diagnostics server 170 for diagnosing errors, and to the receiving client systems, such as the receiving client system 120.

It will also be appreciated that while the present discussion describes the use of threads to process messages, other units of execution can be used, including, but not limited to, processes and lightweight processes. It will also be appreciated that the message server 150 and its parent and thread processes can perform other tasks or similar tasks in other manners. For example, still referring to FIG. 3, the parent process does not have to wait for a connection from a client system since one may already be established. It will be appreciated that the execution of the parent and thread processes illustrated in FIG. 3 can be altered in many ways without departing from the present invention.

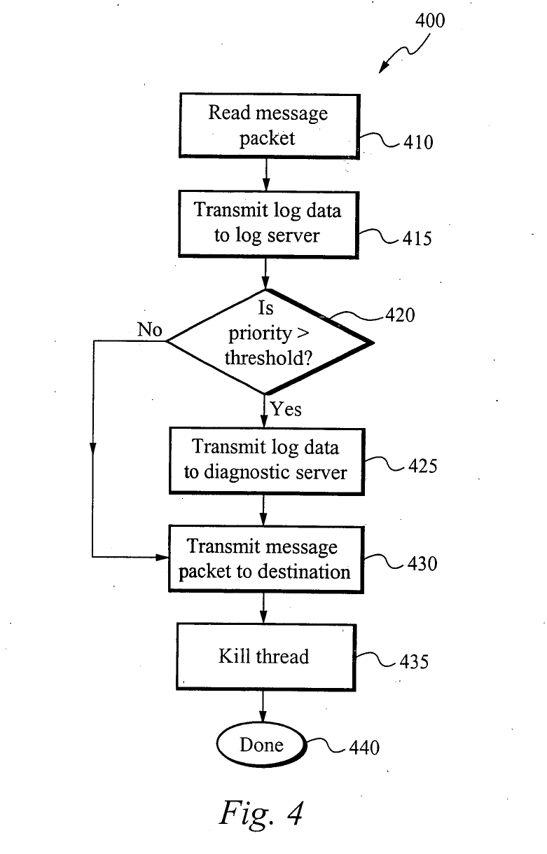

FIG. 4 is a flow chart 400 showing the steps executed by a thread running on the message server 150 (e.g., step 320, FIG. 3) and used to process a message packet. Referring to FIGS. 1 and 4, first, in the step 410, the thread reads the message packet. Next, in the step 415, the thread transmits log data to the log server 160. The message server 150 and the log server 160 can be separate machines or the same machine. If the message server 150 and the log server 160 are separate machines, they can communicate using TCP/IP, NetBUI, or any other transport protocol. If the message server 150 and the log server 160 are the same machine, the message server 150 is implemented as a process or set of processes running on the machine, and the log server 160 is implemented as a process or a set of processes running on the machine.

If the log server 160 and the message server 150 are the same machine, the log server 160 receives incoming message packets containing log data directly from the message server 150. This exchange can be made using the aforementioned client/server communication methods which include, but are not limited to, TCP/IP. Alternatively, the log server 160 and the message server 150 can communicate using shared memory, pipes, or any other method of exchanging data between units of execution running on the same machine.

Similarly, if the message server 150 and the diagnostics server 170 are the same machine, the message server 150 is implemented as a process or a set of processes running on the machine, and the diagnostics server 170 is implemented as a process or a set of processes running on the machine. The diagnostics server 170 that resides on the same machine as the message server 150 receives incoming message packets containing diagnostic (log) data directly from the message server 150. This exchange can be made using the aforementioned client/server communication methods, which include, but are not limited to, TCP/IP. Alternatively, the diagnostics server 170 and the message server can communicate using shared memory, pipes, or any other method of exchanging data between units of execution running on the same machine.

Next, in the step 420, the message server 150 checks the value in a priority field (the priority) of the message packet, indicating the priority of the message. In a preferred embodiment, if the priority is greater than a threshold value, indicating that a diagnostic event has occurred on the sending client system 110, then the message server 150 transmits log data to the diagnostics server 170. As used herein, a diagnostic event is an event that can be diagnosed, such as when manufacturing equipment that is coupled to the sending client system 110 has malfunctioned or should be serviced.

Referring to FIGS. 1 and 4, it will be appreciated that because the log server 160 and the diagnostics server 170 are optional, the steps 415 and 425 are also optional and are included merely to illustrate one embodiment of the present invention.

It will be appreciated that indicia other than the priority can be used to determine whether to transmit log data to the diagnostics server 170. For example, log data for all message packets transmitted between the sending client system 110 and the receiving client system 120 can be transmitted to the diagnostics server 170. Alternatively, log data for all message packets containing a specified string in the message packet can be transmitted to the diagnostics server 170. Alternatively, if a message packet contains tagged data elements, such as in an XML document, a specific element containing predetermined values, such as <DIAGNOSE>YES</DIAGNOSE>, can be used to determine whether to transmit log data to the diagnostics server 170. It will be appreciated that other methods can be used to determine whether to transmit log data to the diagnostics server 170.

If the message has a priority that requires that log data be transmitted to the diagnostics server 170 (e.g., if a diagnostic event has occurred), the step 425 is performed; otherwise, the step 430 is performed. In the step 425, log data is transmitted to the diagnostics server 170, and the step 430 is performed. In the step 430, the message packet is transmitted to the receiving client system 120. It will be appreciated by those skilled in the art that if the message server 150 and the diagnostics server 170 are on separate machines, then the step 425 can comprise, for example, creating or using an existing socket between the message server 150 and the receiving client system 120, similar to the step of creating or using an existing socket between the sending client system 110 and the message server 150, as described above in reference to FIG. 2. Next, in the step 435, the thread or other unit of execution created for processing the message packet (step 320, FIG. 3) is killed. The sequence of steps is then completed in the step 440.

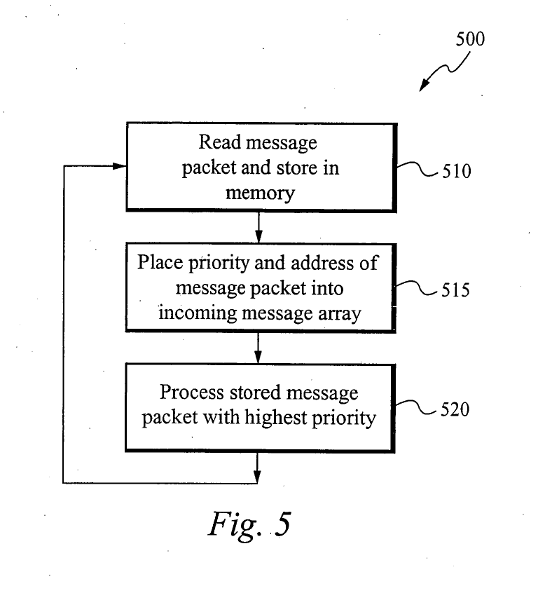

When the message packet has been transmitted from the message server 150 to the receiving client system 120, the messaging module 125 processes the incoming message packet as shown by the sequence of steps 500 illustrated in FIG. 5 in view of FIG. 1. First, in the step 510, the messaging module 125 reads the incoming message packet and stores it in memory. Next, in the step 515, the messaging module 125 stores the priority of the incoming message packet and the reference of the memory where the incoming message packet is stored in an incoming message queue. Next, in the step 520, the messaging module 125 parses the incoming message queue and processes the message packet with the highest priority. The messaging module 125 then loops back to the step 510 to read another incoming message packet.

As discussed above, processing an incoming message packet can comprise many steps, such as sending the contained message to a process running on the receiving client system 120, printing the message to a monitor forming part of the receiving client system 120, forwarding the message packet to another client system coupled to the receiving client system 120, generating an alarm signal on the receiving client system 120, or performing other tasks.

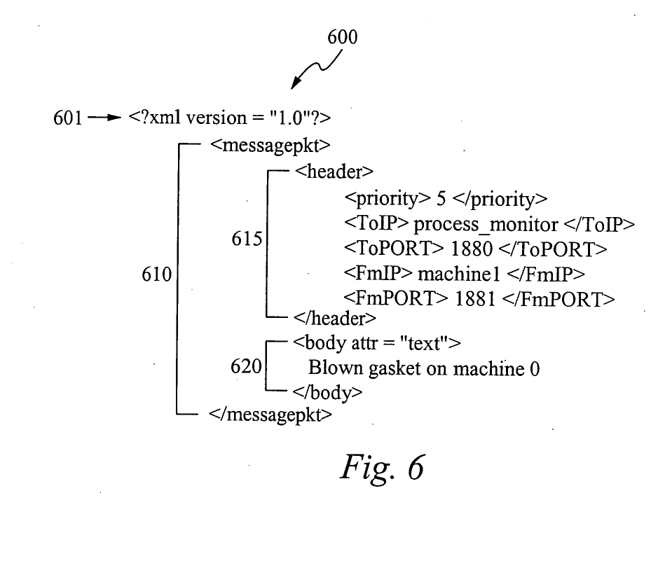

In accordance with the present invention, message packets can have many formats. Preferably, a message packet is an XML document, such as the XML document 600 illustrated in FIG. 6 in view of FIG. 1. The XML document 600 contains an XML declaration (prolog) 601 and a root element, the message packet element 610 having a tag “messagepkt.” The XML declaration 601 <?xml version=“1.0”?> indicates that version 1.0 of XML is being used. The message packet element 610 contains a header element 615 with the tag “header” and a body element 620 with the tag “body”. The header element 615 contains (1) a priority element with the data “5”, indicating that the attached message (discussed below) has a priority of 5; (2) a ToIP element with the data “process_monitor”, indicating that the attached message is to be sent to a receiving client system having the hostname “process_monitor”; (3) a ToPORT element with the data “1880”, indicating that the attached message is to be sent to the port 1880 on the receiving client system 120; (4) a FMIP element with the data “machine1,” indicating that the sending client system 120 has the hostname “machine1”; and (5) a FmPORT element with the data “1881”, indicating that the sending client system 120 will send the message from its port 1881. It will be appreciated that the above elements and their associated data are used for, illustration only and are optional or may have different values. It will also be appreciated that a message server can be used as a name server to translate hostnames to IP addresses in dotted decimal notation, if needed. Alternatively, if a message server is not used, the data in the ToIP element and FmIP element can be any identifiers that a name server, such as a domain name server used on the Internet, can use to forward a message packet from a sending client system to a receiving client system.

The body element 620 has the tag “body” with the data (text data, which is the message of the message packet), “Blown gasket on machine 0.” It will be appreciated that the body element 620 can contain other data having other data types, such as other primitives or software objects.

The XML document 600 can be generated in many ways. Preferably, the XML document 600 is generated using a process running on the sending client system 110. For example, if the sending client system 110 executes JAVA™ instructions, the JAVA™ instructions can serialize an instance of a JAVA™ object, generating the XML document 600. It will be appreciated, however, that the XML document 600 can be generated in other ways. On the receiving client system 120, the XML document can be deserialized to recover the JAVA™ object. Alternatively, the receiving client system 120 can process the XML document 600 to recover the data (message) of the body element 620 without deserializing the XML document 600.

XML documents generated in accordance with the present invention can have tagged elements other than those illustrated in FIG. 6 or in combination with those illustrated in FIG. 6. It will also be appreciated that in accordance with the present invention, messages can be formatted according to a Standard Generalized Markup Language (SGML) standard, of which XML is a subset, or any other formatting standard.

Referring to FIGS. 1, 4, and 6, in accordance with one embodiment of the present invention, after the XML document 600 is generated on the sending client system 110, it is transmitted to the message server 150. The message server 150 reads the message packet and stores it in memory on the message server 150 (step 410, FIG. 4). Next, the message server 150 transmits log data for the message packet to the log server 160 (step 415, FIG. 4). Next, the message server 150 compares the priority of the message packet to a threshold value, for example the value 4 (step 420, FIG. 4). Because the priority (5) is greater than the threshold value (4), the sequence proceeds to the step 425 (FIG. 4), and the log data is transmitted to the diagnostics server 170. Next, the message packet is transmitted to the receiving client system 120 in the step 430. The thread that had been created and dispatched to perform the steps 410, 415, 420, 425, and 430 (step 320, FIG. 3) is now killed in the step 435, and the sequence of steps completes in the step 440.

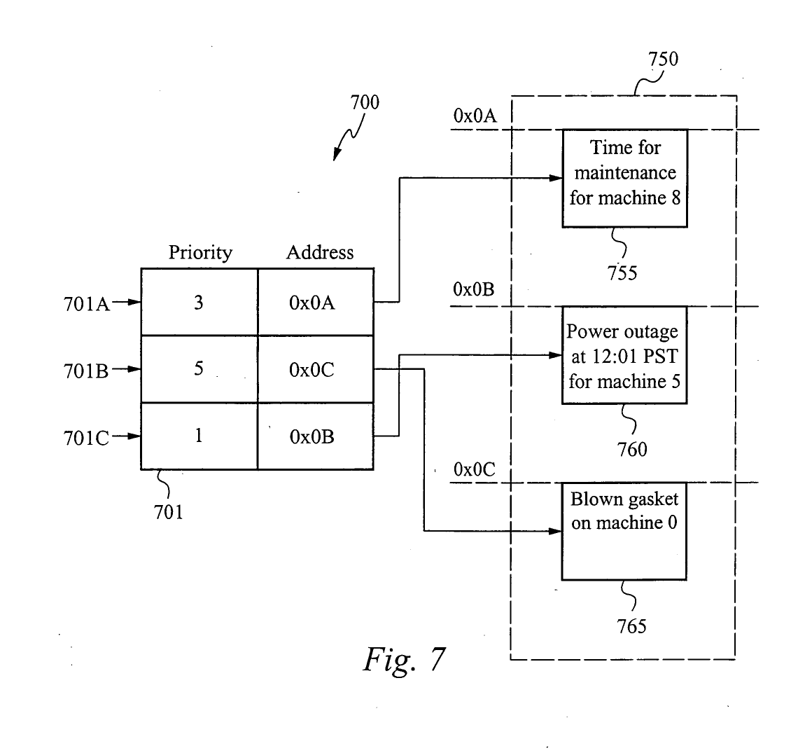

Referring now to FIGS. 1, 5, and 6, the message packet is read on the receiving client system 120 and stored in memory on the receiving client system 120 (step 510, FIG. 5). The memory can be part of the messaging module 125 or can be other memory on the receiving client system 120 shared by the messaging module 125. FIG. 7 illustrates one embodiment of memory 700 in the messaging module 125. Stored in the memory 700 is an incoming message array 701 and a packet memory 750. The packet memory 750 stores incoming message packets for later processing and comprises memory blocks 755, 760, and 765. The incoming message array 701 stores a reference to the incoming message packets in the packet memory 750 and the priority of each incoming message packet. A processing module or other program for processing memory packets traverses the incoming message array 701 and, using priorities, selects a message packet for processing. Preferably, message packets with higher priorities are processed before message packets with lower priorities.

In operation, when the messaging module 125 receives the incoming message packet 600 from the message server 150, the messaging module 125 stores the incoming message packet 600 in the memory block 765 (step 510, FIG. 5). The processing module 125 then stores the reference to the memory block 765 and the priority of the message packet 600 in the element 701B of the incoming message array 701. As illustrated in FIG. 7, the incoming message array 701 indicates that the incoming message 600 is stored in the memory location 0x0C (hexadecimal) and has a priority of 5. FIG. 7 further illustrates two other messages stored in locations 701A and 701C of the incoming message array 701. The message stored in the location 701A has a priority of value 3 and a text message stored in the packet memory block 755 at location 0x0A of the memory 750. The message stored in the location 701C has a priority of 1 and a text message stored in the packet memory block 760 at location 0x0B of the memory 750. Because the message 600 stored in the location 701B of the priority queue 701 has a priority larger than the priorities of the messages stored in locations 701A and 701C of the priority queue 701, the message 600 will be processed before the messages stored in the locations 701A and 701C of the priority queue. Preferably, message packets having the same priority will be handled first-in-first-out (FIFO). Priorities can be interpreted in other ways. For example, a first message packet with a low value in a priority field can be considered more urgent than a second message packet with a larger value in its priority field. The first message packet can then be processed before the second message packet by, for example, sending the message packet to a program running on the receiving client system 120.

It will be appreciated that the incoming message packets can be processed in ways other than as described above. For example, a messaging module can sort the incoming message array so that references to message packets are stored in order of increasing or decreasing priority. The messaging module could then process message packets by their location in the incoming message array 701. In this way, the incoming message array 701 functions as a priority queue. Alternatively, the messaging module 125 can process incoming message packets round robin, first-in-first-out (FIFO), or last-in-first-out (LIFO). Alternatively, a messaging module can dispatch threads to process each message packet. The messaging module can then use the operating system executing on the receiving client system to assign a priority to each thread. Thus, the operating system's scheduler will use the priorities assigned to each thread to determine when a thread will run, and thus when a message packet will be processed. For example, when the operating system executing on the receiving client system is Unix or a Unix-related operating system, the processing module can execute the NICE command to assign an execution priority to a thread or other unit of execution that processes a message packet. It will be appreciated that in accordance with the present invention, other methods can be used to process message packets based on a priority.

The messaging modules 115 and 125 of FIG. 1 preferably include the memory 700 (FIG. 7) and one or more units of execution that (1) format messages into message packets, (2) establish a connection between a client system 110 and 120 and the message server 150, (3) exchange message packets between a client system 110 and 120 and the message server 150, (4) store message packets in the memory 700, and (5) process message packets stored in the memory 700 by, for example, transmitting them to a unit of execution running on a client system 110 and 120. Alternatively, the messaging modules 115 and 125 can perform tasks other than or in addition to those described above.

For simplicity, FIG. 7 illustrates only the values of the body element of each message packet. Thus, for example, while packet memory block 765 shows the text “Blown gasket on machine 0,” it will be appreciated that the packet memory block 765 will contain the header tags and values shown, for example, in FIG. 6. Similarly, the packet memory blocks 755 and 760 will contain tags and their values that are not shown in order to simplify the illustrations of the packet memory blocks 755 and 760.

It will also be appreciated that the messaging module 125 or a process running on the receiving client system 120 can use the tags in the XML document 600 for other means. For example, a receiving process can use tags in the XML document 600 to determine whether to highlight a message in the message packet, cause it to appear as a flashing value, cause it to be displayed in other ways, trigger an alarm bell, or perform other actions.

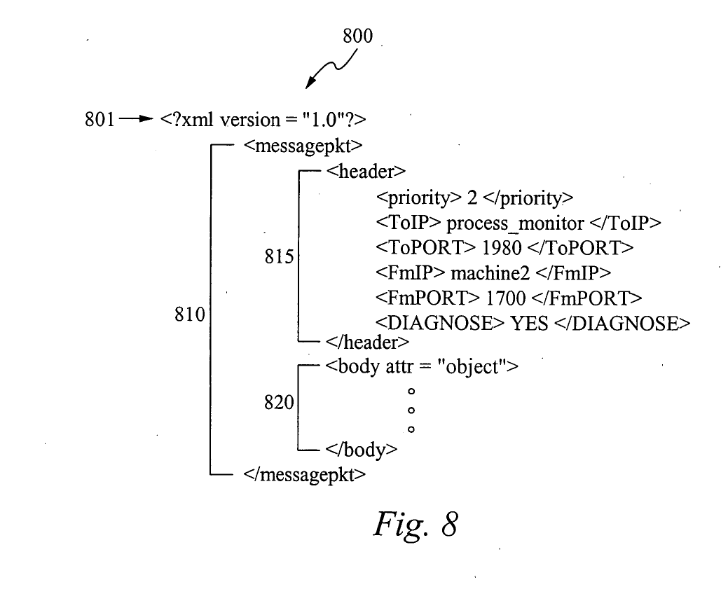

FIG. 8 shows another embodiment of an XML document 800 (i.e., message packet) that can be used in accordance with the present invention. The XML document 800 contains an XML declaration (prolog) 801 and a root element, the message packet element 810 having the tag “messagepkt”. The XML declaration 801 <?xml version=“1.0”?> indicates that version 1.0 of XML is being used. The message packet element 810 contains a header element 815 with the tag “header” and a body element 820 with the tag “body”. The header element 815 contains (1) a priority element with the data “2”, indicating that the attached message (discussed below) has a priority of 2; (2) a ToIP element with the data “process_monitor”, indicating that the attached message is to be sent to a receiving client system with the hostname “process_monitor”; (3) a ToPORT element with the data “1980”, indicating that the attached message is to be sent to the port 1980 on the receiving client system; (4) a FmIP element with the data “machine2”, indicating that the sending client system has the hostname “machine2”; (5) a FmPORT element with the data “1700”, indicating that the sending client system will send the message on its port 1700; and (6) a DIAGNOSE element with the data “YES,” indicating that the message should be transmitted to a diagnostics server.

The body element 820 has the attribute value “object”, which indicates that the attached body (i.e., the message) is a data object. The body element 820 further contains the data object (not shown), which can include text-data, executable instructions, or other object data. A receiving client system can use this data object to execute software instructions or to perform other tasks.

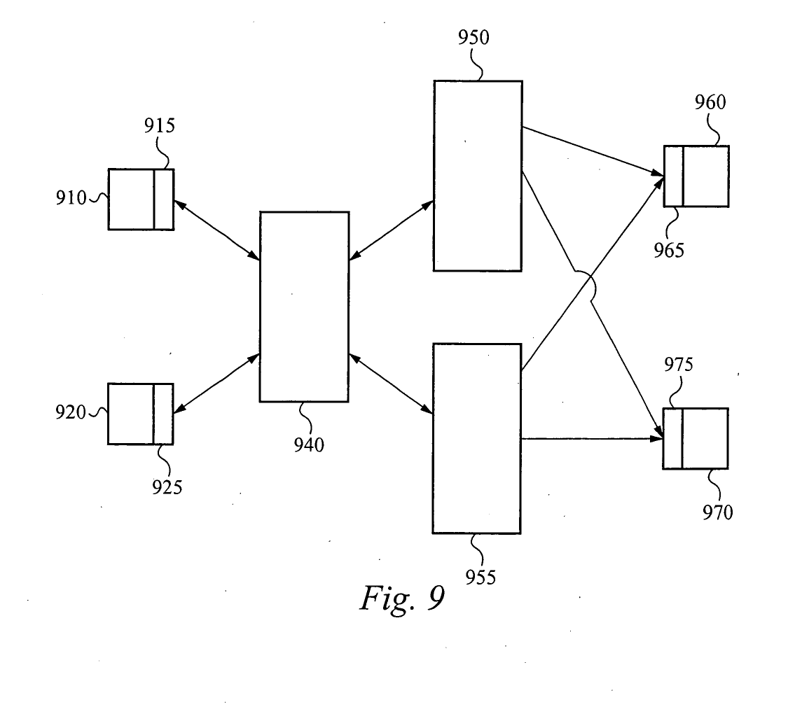

FIG. 9 shows a load-balanced message-passing system 900 that balances message packet transmissions between two message servers 950 and 955. Thus, when one message server is busy processing a message packet, a message packet can be sent to and processed by another message server, thus increasing overall system throughput. The load-balanced message-passing system 900 comprises a first client system 910 having a messaging module 915 and a second client system having a messaging module 915; a load-balancer 940 coupled to both the first messaging module 915 and the second messaging module 925; a first message server 950 and a second message server 955, both coupled to the load balancer 940; a log server 960 coupled to both the first message server 950 and the second message server 955 and having a messaging module 965; and a diagnostics server 970 coupled to both the first message server 950 and the second message server 955 and having a messaging module 975.

Preferably, the first message server 950 and the second message server 955 are mirrors of each other, communicating with the client systems 910 and 920 in the same way, communicating with the log server 960 in the same way, and communicating with the diagnostics server 970 in the same way.

In operation, for example, the messaging module 915 generates a message packet for transmission to the second client system 920. The message packet is transmitted to the load balancer 940, which determines the load on the first message server 950 and the second message server 955. If the first message server 950 has a load below a threshold value, the load balancer 940 transmits the message packet to the message server 950, which processes the message packet as described above. If the first message server 950 has a load above the threshold value, the load balancer 940 transmits the message packet to the message server 955, which processes the message packet as described above. Because the message servers 950 and 955 perform identical tasks, the message servers 950 and 955 process the message packet in identical manners.

When the message packet has been processed, including optionally transmitting log data to the log server 960, the diagnostics server 970, or both as described above, the message server that processed the message packet next transmits the message packet to the load balancer 940, which in turn transmits the message packet to the messaging module 925 on the receiving client system 920.

Message-passing systems that transmit prioritized messages can be used to ensure that messages are handled expeditiously. Message-passing systems can be used in many environments, such as manufacturing environments. For example, a message-passing system can include manufacturing equipment coupled to a client system. The client system can read one or more parameters related to the manufacturing equipment, such as an operating temperature or pressure, and transmit a message packet containing the message to a second client system, such as a control system. The message can be prioritized, based on the value of the parameter. The second client system can receive the message packet, processing higher-priority messages first, and take appropriate actions. Messages can also be logged for record-keeping or sent to a diagnostics server, which can be used to diagnose problems with the manufacturing equipment.

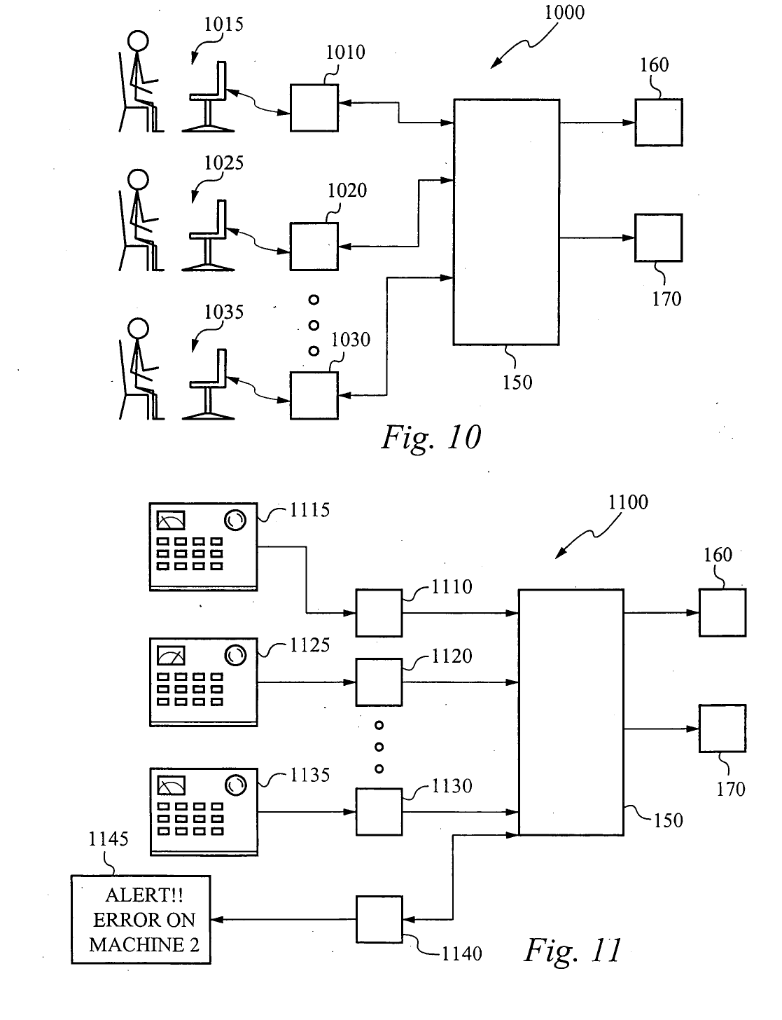

FIG. 10 illustrates a message-passing system 1000 in accordance with one embodiment of the present invention. The message-passing system 1000 comprises the message server 150, a log server 160, and a diagnostics server 170, all discussed above in relation to FIG. 1. The message passing system 1000 further comprises a client system 1010 coupled to the message server 150 and a workstation 1015, a client system 1020 coupled to the message server 150 and a workstation 1025, through a client system 1030 coupled to the message server 150 and a workstation 1035. To simplify the illustration, messaging modules are not illustrated on the client systems 1010, 1020, through 1030, but it will be appreciated that the client systems 1010, 1020, through 1030 each has a messaging module for sending and receiving prioritized messages in accordance with the present invention. Each workstation uses its client system to send and receive messages to another workstation. For example, the client system 1010 can receive a prioritized message from the workstation 1015 and transmit the prioritized message to the client system 1030, which in turn transmits the message to the workstation 1035. Each workstation can comprise a computer terminal and a keyboard so that individuals can, for example, compose, transmit, receive, and read electronic messages in accordance with the present invention.

FIG. 11 illustrates a message-passing system 1100 used in a manufacturing environment, in accordance with another embodiment of the present invention. Like-numbered elements in FIGS. 10 and 11 perform similar functions. In addition to common elements illustrated in FIG. 10, the message-passing system 1100 comprises a client system 1110 coupled to the message server 150 and manufacturing equipment 1115, a client system 1120 coupled to the message server 150 and manufacturing equipment 1125, through a client system 1130 coupled to the message server 150 and manufacturing equipment 1130, and a client system 1140 coupled to the message server 150 and a control/alert system 1145. In operation, the client systems 1110, 1120, through 1130 monitor operating conditions of the manufacturing equipment 1115 and 1125 through 1135, such as a temperature and pressure of the manufacturing equipment. The client systems 1110, 1120, through 1130 then send prioritized messages to the control/alert system 1145, through the client system 1140, in accordance with the present invention. The client system 1140 will process the messages based on a priority and pass the messages to the control/alert system 1145 based on the priority. The control/alert system 1145 can then perform a function, such as generate an alert signal or a flashing message. It will be appreciated that manufacturing equipment 1115, 1125, through 1135 can be any kind or combination of manufacturing equipment, such as semiconductor processing systems, located in diverse locations.

It will be appreciated that client systems, message servers, log servers, and diagnostics servers can be implemented in many ways, using many programming languages to create processes that process message packets. For example, client systems can implement processes in procedural programming languages, such as C; object-oriented programming languages, such as JAVA™ and C++; or scripting languages, such as PERL or UNIX shell scripts. Preferably messaging modules are implemented in an object-oriented programming language and include a mailbox and a connection object.

It will be readily apparent to one skilled in the art that other various modifications may be made to the embodiments without departing from the spirit and scope of the invention as defined by the appended claims.

1: A message-passing system, comprising:
a. a first client system coupled to a semiconductor processor system and programmed to transmit a message packet containing a priority corresponding to a state of the semiconductor processing system;
b. a diagnostics server coupled to the first client system the diagnostics server programmed to store log data corresponding to the message packet and to map an error code corresponding to the state to a corrective action; and
c. a second client system programmed to receive the message packet transmitted from the first client system and process the message packet in an order relative to other message packets based on the priority.

2. The message-passing system of claim 1, wherein the first client system is programmed to transmit the message packet to the second client system according to a transport protocol.

3. The message-passing system of claim 2, wherein the transport protocol is TCP/IP.

4. The message-passing system of claim 2, wherein the transport protocol is NetBEUI.

5. The message-passing system of claim 1, wherein the message packet is formatted according to an SGML standard.

6. The message-passing system of claim 5, wherein the SGML standard is XML.

7. The message-passing system of claim 6, wherein the message packet comprises text data.

8. The message-passing system of claim 6, wherein the message packet comprises a virtual object.

9. The message-passing system of claim 1, further comprising a first message server coupling the first client system to the second client system, the first message server providing a first communication path between the first client system and the second client system.

10. The message-passing system of claim 9, further comprising a log server coupled to the first message server, the log server programmed to store log data for the message packet.

11. (canceled)

12. The message-passing system of claim 9, further comprising:
a second message server coupled to the first client system and the second client system, the second message server providing a second communication path between the first client system and the second client system; and
a load balancer coupling the first client system to both the first message server and the second message server, the load balancer further coupling the second client system to both the first message server and the second message server.

13. The message-passing system of claim 1, wherein the semiconductor processing system has an associated parameter, the first client system is programmed to monitor the associated parameter, generate the priority based on the parameter, generate the message packet containing the priority, and transmit the message packet to the second client system.

14. (canceled)

15. A method of passing a message packet between a first client system and a second client system, the method comprising:
a. generating the message packet containing a priority on the first client system, wherein the priority corresponds to a state of a semiconductor processing system;
b. transmitting the message packet from the first client system to the second client system and a diagnostics server, wherein the diagnostics server comprises a data store mapping the priority to a corrective action;
c. receiving the message packet on the second client system; and
d. processing the message packet on the second client system in an order relative to other message packets stored on the second client system based on the priority.

16. The method of claim 15, wherein the message packet is transmitted from the first client system to the second client system according to a transport protocol.

17. The method of claim 16, wherein the transport protocol is TCP/IP.

18. The method of claim 16, wherein the transport protocol is NetBEUI.

19. The method of claim 15, wherein generating the message packet comprises formatting a message according to an SGML standard.

20. The method of claim 19, wherein the SGML standard is XML.

21. The method of claim 20, wherein the message packet comprises text data.

22. The method of claim 20, wherein the message packet comprises a virtual object.

23. The method of claim 15, further comprising storing log data for the message packet.

24. The method of claim 15, wherein transmitting the message packet comprises:
transmitting the message packet to a message server based on a load of the message server; and
transmitting the message packet from the message server to the second client system.

25. The method of claim 15, wherein generating the message packet comprises encrypting a message to generate an encrypted message and including the encrypted message in the message packet.

26. The method of claim 25, wherein processing the message packet comprises decrypting the encrypted message in the message packet.

27. The method of claim 15, further comprising before the step (a):
reading a parameter associated with a manufacturing equipment; and
generating the priority based on the parameter.

28-35. (canceled)

36. The message-passing system of claim 1, wherein the second client system comprises a priority queue structured for processing the message packet in the order based on the priority.

37. The message-passing system of claim 1, wherein the first client system is programmed to include a tag within the message packet when the priority is above a threshold, thereby indicating the occurrence of a diagnostics event on the first client system, and the message server is programmed to transmit to the diagnostics server all message packets that include the tag.

38. The method of claim 15, further comprising taking the corrective action on the first client system, wherein taking the corrective action comprises cooling an area containing the semiconductor processing system.
